(19) United States
(12) Patent Application Publication
(10) Pub. No.: US 2016/0040830 A1
(43) Pub. Date: Feb. 11, 2016

(54) CRYOGENIC ASSEMBLY INCLUDING CARBON NANOTUBE ELECTRICAL INTERCONNECT

(71) Applicant: Raytheon Company, Waltham, MA (US)

(72) Inventors: James R. Chow, San Gabriel, CA (US); Theodore J. Conrad, Redondo Beach, CA (US); David M. La Komski, Long Beach, CA (US)

(21) Appl. No.: 14/565,513

(22) Filed: Dec. 10, 2014

Related U.S. Application Data
(60) Provisional application No. 62/035,689, filed on Aug. 11, 2014.

(51) Int. Cl. F17C 7/02; H01B 9/00; H01B 1/04

(52) U.S. Cl. CPC F17C 7/02; H01B 1/04; H01B 9/006

(57) ABSTRACT

A cryogenic assembly includes a platform configured to support at least one electronic component. A cryocooler is thermally connected to the platform to cool the platform to a cryogenic temperature. A vacuum unit includes a housing that surrounds a cavity configured to receive the platform. The vacuum unit is configured to thermally insulate the cavity from surrounding ambient air surrounding. At least one connector is configured to deliver an electrical signal from a power supply to the cryogenic assembly. The connector includes at least one carbon nanotube interconnect that inhibits heat flow into cryogenic assembly while delivering the electrical signal.

### CROSS-REFERENCE TO RELATED APPLICATION

This application is a non-provisional of U.S. Patent Application Ser. No. 62/035,689, filed Aug. 11, 2014, the disclosure of which is incorporated by reference herein in its entirety.

### BACKGROUND

The present disclosure relates generally to cryogenic superconductor assemblies, and more specifically, to electrical interconnects configured to route electrical signals to cryogenic assemblies.

Cryogenic assemblies are being pursued to house superconducting components and circuitry. When placed in cryogenic conditions, superconducting circuits and components provide a significant performance increase (e.g., approximately 10×-20×) compared to conventional semiconductor components. Cryogenic temperatures within the cryogenic assembly must be sustained to achieve the performance increase.

An example of a conventional cryogenic assembly 10 is illustrated in FIG. 1. Conventional cryogenic assemblies 10 typically include a cryocooler 12 and a vacuum assembly 14. The cryocooler 12 is in thermal communication with a platform 16, and operates to cool the platform 16 to cryogenic temperatures. The vacuum assembly 14 operates to thermally insulate a cavity 18 designed to receive the platform 16. A sensor 20 is disposed within the cavity 18 and outputs a temperature signal indicating the internal temperature of the cavity 18. The cryocooler 12 receives the temperature signal and operates to maintain the platform 16 at the set cryogenic temperatures. Therefore, any parasitic heat flux that enters into the vacuum assembly 14 and/or cavity 18, for example, must be compensated by increasing the work output of the cryocooler 12. Consequently, the parasitic heat flux reduces the overall efficiency of conventional cryogenic assemblies 10.

One of the largest contributors of parasitic heat flux intrusion into the vacuum assembly 14 is the electrical connector 22 that carries electrical signals such as for example, power and control signals, to the electronics mounted inside the vacuum assembly (i.e., the dewar). One or more wires 24 of the connector 22, however, are thermally conductive and typically emit heat (T1) when delivering the power and/or electrical signals. Consequently, parasitic heat flux is allowed to enter into the vacuum assembly 14 via the wires 24. Therefore, the power consumption and work output of the cryocooler 12 increases as parasitic heat flux into the vacuum assembly 14 increases.

### SUMMARY

According to an embodiment, cryogenic heat flow reduction assembly comprises a platform configured to support at least one electronic component, and a housing that defines a cavity in which the platform is disposed. The housing is configured to thermally insulate the cavity from surrounding ambient air such that the cavity is maintained at a cryogenic temperature. The cryogenic heat flow reduction assembly further includes at least one connector configured to deliver an electrical signal from a source external to the housing. The at least one connector includes at least one carbon nanotube interconnect that inhibits heat flow into the cavity while delivering the electrical signal.

According to another embodiment, a connector comprises at least one conductive element including a first end configured to receive an electrical signal and a second end configured to output the electrical signal to a cryogenic assembly. The connector further includes at least one carbon nanotube interconnect interposed between the first end and the second end. At least one carbon nanotube interconnect is configured to inhibit heat flow to the second end while maintaining electrical conductivity between the first end and the second end.

According to yet another embodiment, a method of improving power efficiency of a cryogenic assembly comprises outputting an electrical signal to a first portion of an electrical connector. The electrical signal induces a heat flow through the first portion of the electrical connector. The method further includes inhibiting the heat flow from flowing to a second portion of the electrical connector, where the portion of the electrical connector exists at a cryogenic temperature. The method further includes delivering the electrical signal to the second portion of the electrical connector. The second portion is electrically connected to the cryogenic assembly such that the power efficiency is improved.

Additional features are realized through the techniques of the present invention. Other embodiments and features of the invention are described in detail herein and are considered a part of the claimed invention. For a better understanding of the invention with the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a block diagram illustrating a conventional cryogenic assembly;

FIG. 2 is a block diagram illustrating a cryogenic assembly according to an exemplary embodiment;

FIG. 3 is a table showing the direct current (DC) conductivity of copper (Cu), constantan, and carbon nanotube material;

FIGS. 4A-4C are tables showing the thermal insulating capability of CNT material;

FIG. 5A is a line graph projecting the thermal conductivity of a doped CNT material at lower temperatures;

FIG. 5B is a table showing the thermal conductivity of a doped CNT material;

FIG. 6 is a line graph showing the electrical resistance of a CNT element; and

FIG. 7 is a flow diagram illustrating a method of improving power efficiency of a cryogenic assembly according to a non-limiting embodiment.

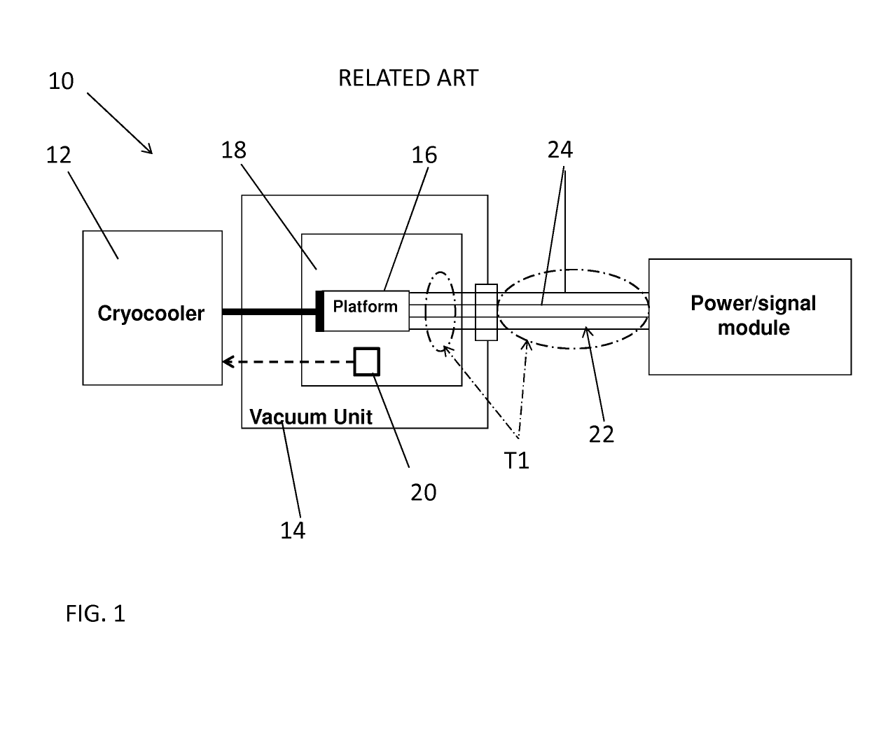

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection. It should be understood that throughout the drawings, corresponding reference numerals indicate like or corresponding parts and features. As used herein, the term module, unit and/or element can be formed as processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

According to a non-limiting embodiment, a cryogenic assembly is provided which includes one or more electrical conductors that provide power and/or other electrical signals to the cryogenic assembly. The electrical conductors include one or more carbon nanotube (CNT) interconnects formed therein that reduce parasitic heat flow into the cryogenic assembly while still providing sufficient conductivity to deliver power and/or signals to the cryogenic assembly. That is, CNT interconnects can be formed on the cryo-side of the connector (e.g., disposed within the vacuum unit) to block the heat flow into the cryogenic assembly while passing the electrical power and signals. The CNT interconnects provide lower overall power requirements necessary for driving the cryogenic assembly. Accordingly, the overall size, weight, and power consumption (SWaP) of the cryogenic assembly can be reduced.

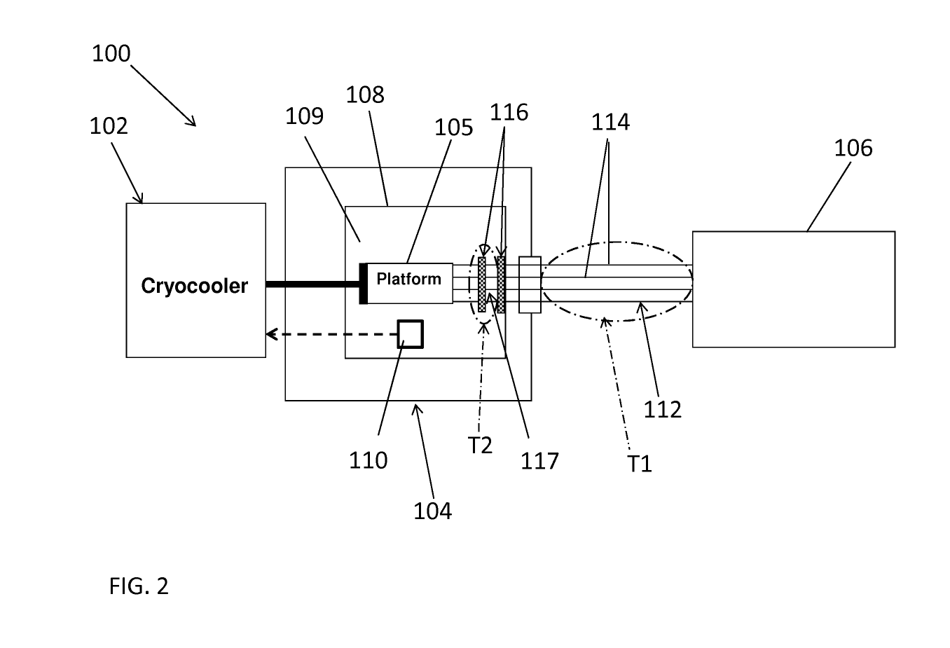

Referring to FIG. 2, a cryogenic assembly 100 is illustrated according to an exemplary embodiment. The cryogenic assembly 100 incudes a cryocooler 102, a vacuum unit 104, and an electronic power control module 106. The cryocooler 102 is thermally connected to a platform 105, and operates to cool the platform 105 to cryogenic temperatures of approximately 120 K or less.

The electronic power control module 106 is electrically connected to the vacuum unit 104 via one or more connectors 112. According to an embodiment, the electronic power control module 106 can be configured as a power supply, for example. Each connector 112 can include one or more electrically conductive elements 114 such as, for example, copper wires 114. A first end of the conductive element 114 is connected to the electronic power control module 106 while a second end is connected to the vacuum unit 104. In this manner, the conductive elements 114, i.e., copper wires 114, deliver electrical power and/or control signals from the electronic power control module 106 to the vacuum unit 104. One or more of the electrically conductive elements 114 are also thermally conductive and can emit heat (T1) when delivering power and/or electrical signals from the power control module 106.

The vacuum unit 104 includes a thermal shielding 108 that defines a cavity 109 configured to receive the platform 105. According to an embodiment, the electronic power control module 106 supplies power to the vacuum unit 104. The vacuum unit 104 in turn operates to thermally insulate the cavity 109 from the surrounding external ambient temperature such that the platform 105 is maintained at a desired cryogenic temperature. A sensor 110 is disposed within the cavity 109 and outputs a temperature signal indicating the internal temperature of the cavity 109. Based on the temperature signal, the cryocooler 102 operates to cool the platform 105 at a desired cryogenic temperature.

The connector 112 includes one or more CNT interconnects 116. The CNT interconnects 116 include, for example, a plurality of carbon nanotubes entangled with one another in a yarn-like arrangement. According to an embodiment, the carbon nanotubes include, for example, a combination of semiconductor and metallic nanotubes formed as a matrix material. At cryogenic temperatures (e.g., approximately 120 K or less), the thermal heat flow of the carbon nanotubes are significantly reduced (e.g., X% when compared to thermal heat flow at ambient room temperatures) while the electrical conductivity of the carbon nanotubes still exists. In this manner, the CNT interconnects 116 can block heat flow into the cryogenic assembly 100 while still passing the electrical power and signals delivered by the power control module 106 as discussed in greater detail below.

The CNT interconnects 116 can be spliced in-between portions of one or more conductive elements 114 using, for example, an electroplating and soldering process. Inserting or splicing the sections of the CNT interconnects 116 in-line with the conductive elements 114 minimizes resistive losses and provides significant thermal insulation such that the heat flow entering the cryo-interface of vacuum unit 104 is inhibited. The output of one or more CNT interconnects 116 can be connected to the platform 105 and/or a device supported by the platform. According to an embodiment, the CNT interconnects 116 may have a length of, for example, approximately 0.002 inches (1.0 millimeters), or less. This length, however, is not limited thereto and can be increased. For those applications where short lengths of the CNT interconnect 116 are not tolerable, the diameter of the CNT interconnect 116 can be increased to lower the impact of reduced electrical conductivity. According to an embodiment, the direct current (DC) electrical conductivity of CNT interconnect 116 is approximately 200 times lower than copper at room temperature. However, the CNT interconnect 116 can still conduct electrical power and other signals with minimized loss when very short sections are spliced between conductive segments 117 and the remaining portion of a respective conductive element 114, e.g., copper wire, that is connected directly to the electronic power control module 106.

The thermal conductivity of the CNT interconnects 116 dramatically decreases since heat energy is moved through the matrix material mainly by phonon (rather than electronic) interaction which is greatly reduced. Accordingly, the thermal conductivity of the CNT interconnects 116 is less than the thermal conductivity of the conductive elements 114. These combined properties allow the CNT wire interconnects 116 to conduct electrical signals, while inhibiting heat flow therethrough. As a result, the temperature (T2) of conductive segments 117 spliced to the CNT wire interconnects 116 is less than the temperature (T1) of the conductive elements 114 that are connected directly to the power control module 106. Since the conductive elements 114 (e.g., copper wires) typically contribute to the highest heat flow into conventional cryogenic assemblies, at least one embodiment of the present disclosure includes CNT interconnects 116 that result in lower cryocooler power requirements, while still achieving desired cryogenic temperatures.

The substantial and unexpected thermal conductivity reduction at cryogenic temperature achieved using one or more CNT interconnects 116 act as a thermal insulator that resists heat flow (i.e., heat flow) along the wire allows for a cryogenic assembly 100 having a reduction in overall size, weight, and power (SWaP). In this manner, the cryocooler power efficiency (i.e., the amount of power required to maintain a desired cryogenic temperature of the cavity 109 and/or the platform 105) is improved. Furthermore, a compact cryocooler with increased power efficiency coupled with reduced thermal parasitic behavior can lead to implementation of superconducting electronics across multiple platforms (e.g., ground, ships, airborne, and space).

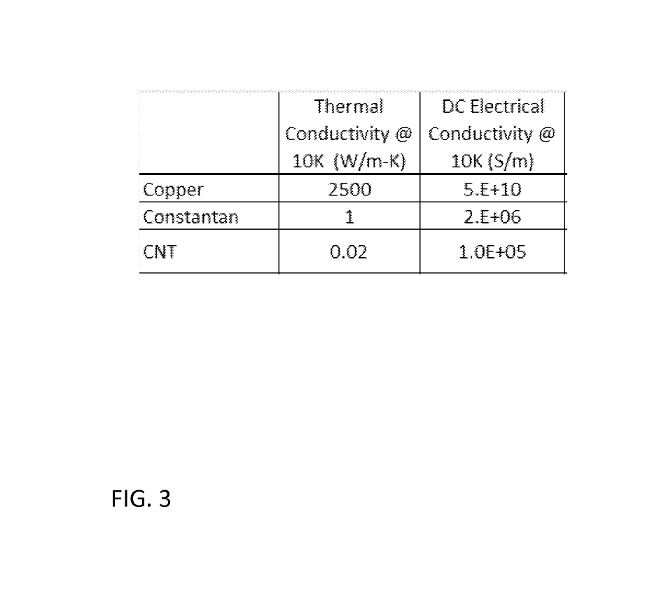

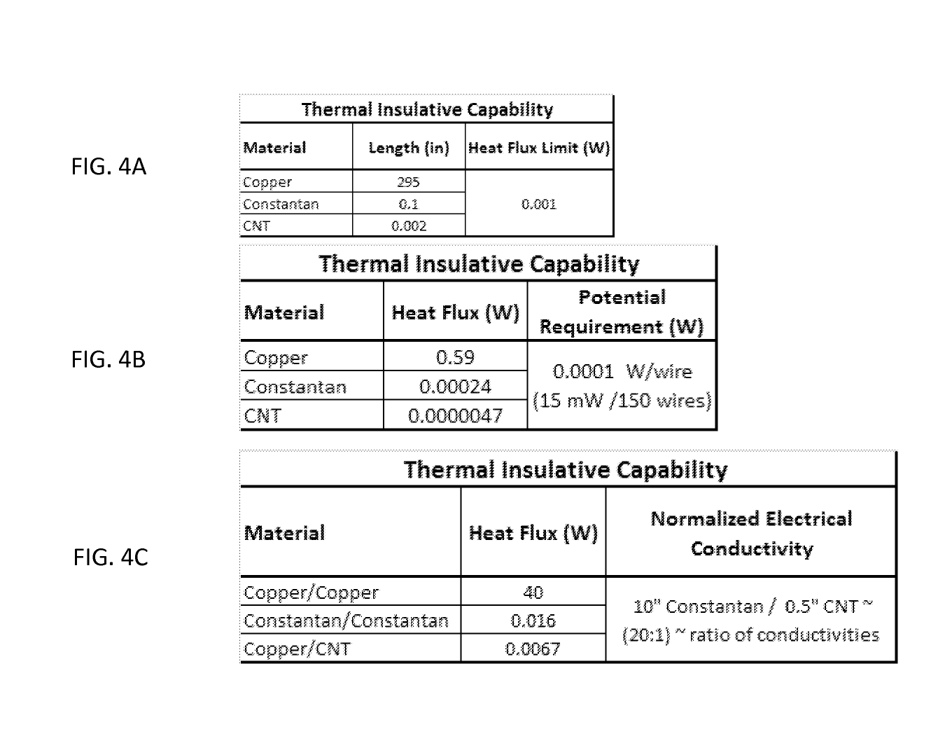

Referring to FIG. 3, a table shows the DC conductivity of copper (Cu), constantan, and carbon nanotube materials. As further shown in FIG. 3, the CNT material has a substantially reduced thermal conductivity with respect to copper and constantan, while still providing electrical conductivity. Both thermal and electrical conductivity of the CNT material is extrapolated from room temperature (RT) measurements. Turning now to FIGS. 4A-4C, the thermal insulating capability of CNT material is described in greater detail. Referring to FIG. 4A, the length of copper, constantan, and CNT materials necessary to achieve a 0.001 watt (Watt) heat flow limit is shown. Accordingly, a significantly less amount of CNT material is needed to achieve a heat flow of 0.001 W.

Referring to FIG. 4B, the heat flow of a 0.5 inch length of copper, constantan, and CNT material is shown. The CNT material is shown to provide significantly less heat flow with respect to copper and constantan.

Referring to FIG. 4C, the heat flow corresponding to three wire/interconnect combinations are shown. A first wire/interconnect including a 10 inch copper wire and a 0.5 inch copper interconnect has a heat flow of 40 W. A second wire/interconnect including a 10 inch constantan wire and a 0.5 inch constant interconnect has a heat flow of 0.016 W. A third wire/interconnect including a 10 inch coper wire and a 0.5 inch CNT interconnect has a heat flow of 0.0067 W.

The heat flow discussed above can be calculated using the following equation (1):

Q=K*A*ΔT/L (1),

where

Q=heat flow;

K=thermal conductivity constant of the conducting material;

A=cross-sectional area of the conducting material;

ΔT=Temperature differential of the conducting material; and

L=length of the conductor

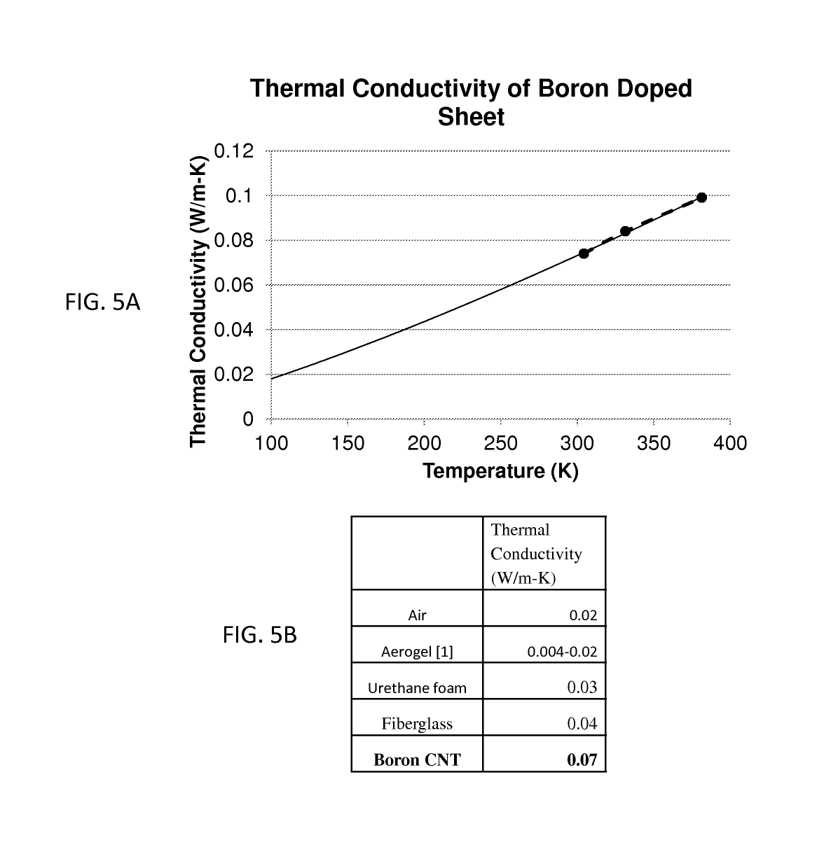

Turning to FIGS. 5A-5B, the projected thermal conductivity of a doped CNT material at cryogenic temperatures is shown. Referring to FIG. 5A, a line graph illustrates the thermal conductivity of a carbon nanotube sheet material. In this example, the carbon nanotube sheet material is doped with, for example, boron with respect to temperature. Turning to FIG. 5B, a table shows the thermal conductivity of boron (B) doped CNT material is comparable to well-known thermal insulating materials including, but not limited to, air, aerogel, urethane foam, and fiberglass. It can be appreciated therefore, that the thermal conductivity of the CNT material is comparable to several well-known thermal insulator, while also providing the additional feature of providing high-conductivity not achieved by conventional well-known thermal insulator materials.

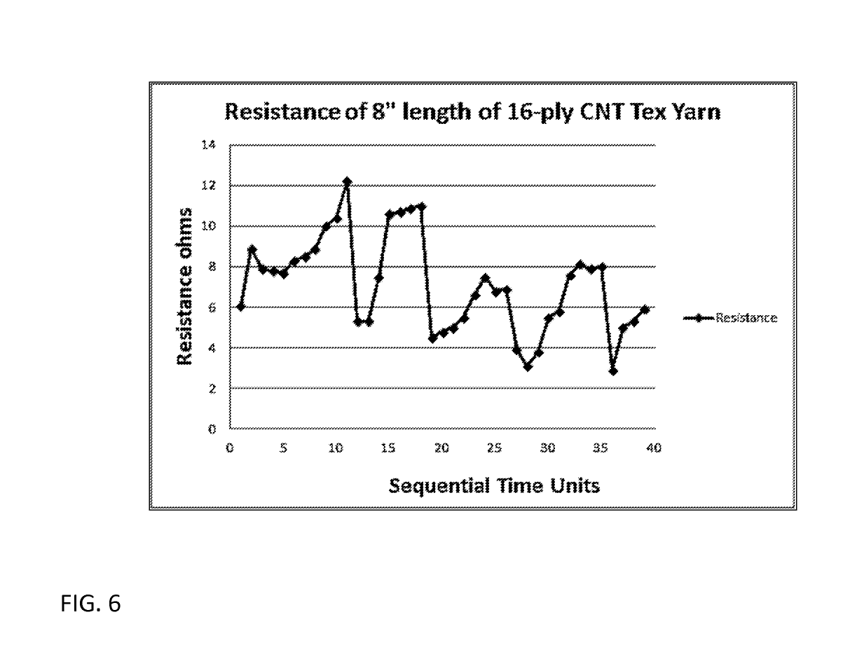

Referring to FIG. 6, a line graph illustrates the electrical resistance of a CNT element after repeated exposure to liquid nitrogen. The CNT element continues to show significant electrical conductivity while being cooled to cryogenic temperatures. The CNT element has, for example, a length of 8 inches and a diameter of 0.010 inches.

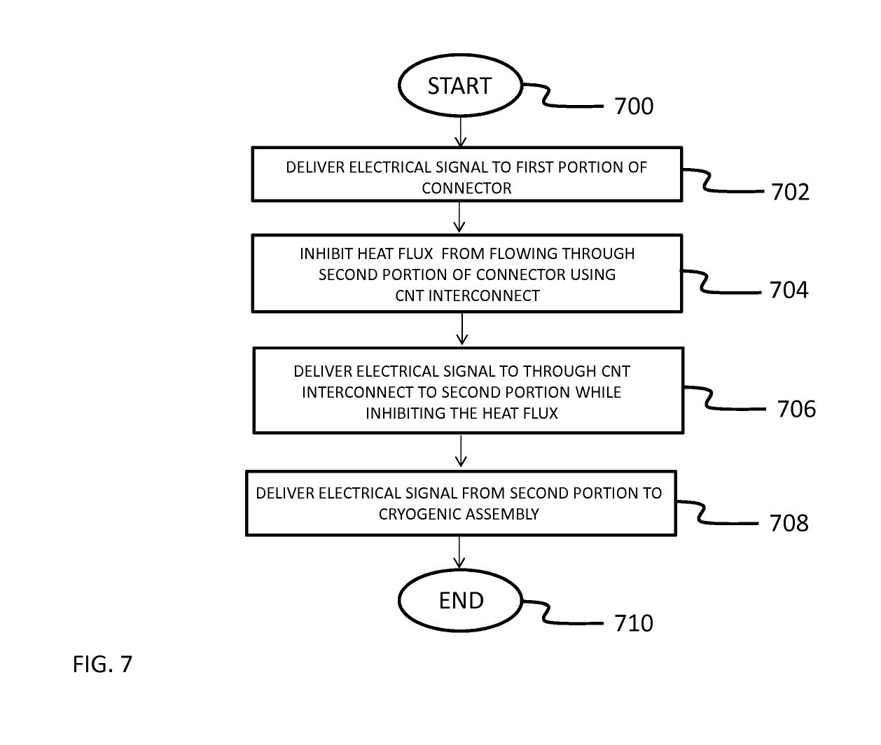

Turning now to FIG. 7, a flow diagram illustrates a method of improving power efficiency of a cryogenic assembly according to a non-limiting embodiment. The method begins at operation 700, and an electrical signal is delivered to a first portion of an electrical connector at operation 702. According to an embodiment, an electronic power control module outputs a power signal to the first portion of the connector. The electrical signal induces a heat flow through the first portion of the electrical connector. At operation 704, the heat flow is inhibited from flowing to a second portion of the electrical connector. According to an embodiment, one or more carbon nanotube interconnects are interposed between the first portion of the connector and the second portion. At operation 706, the electrical signal is delivered to the second portion of the electrical connector while blocking the heat flow. According to an embodiment, the second portion of the connector is electrically connected to the cryogenic assembly such that the electrical signal is delivered to the cryogenic assembly at operation 708, and the method ends at operation 710. In this manner, parasitic heat flow is blocked from entering the cryogenic assembly such that the power efficiency of the cryogenic assembly is improved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the various embodiments to the invention have been described, it will be understood that those skilled in the art, both now and in the future, may make various modifications and enhancements which fall within the scope of the claims which follow. These claims should be construed to maintain the proper protection for the invention first described.

What is claimed is:

1. A cryogenic heat flow reduction assembly, comprising:
a platform configured to support at least one electronic component;
a housing that defines a cavity in which the platform is disposed, the housing configured to thermally insulate the cavity from surrounding ambient air such that the cavity is maintained at a cryogenic temperature; and
at least one connector configured to deliver an electrical signal from a source external to the housing, the at least one connector including at least one carbon nanotube interconnect that inhibits heat flow into the cavity while delivering the electrical signal.

2. The cryogenic assembly of claim 1, further comprising:
a cryocooler including a vacuum unit coupled to the housing, and configured to cool the cavity to the cryogenic temperature, wherein the at least one connector includes a first portion having a first thermal conductivity and a second portion having a second thermal conductivity that is less than the first thermal conductivity.

3. The cryogenic assembly of claim 2, further comprising:
an electronic power control module configured to generate the power, wherein the at least one connector includes a first end electrically connected to the electronic power control module and a second end electrically connected to the vacuum unit.

4. The cryogenic assembly of claim 3, wherein the first end of the connector is configured to emit a first temperature and the second end of the connector is configured to emit a second temperature that is less than the first temperature.

5. The cryogenic assembly of claim 4, wherein the at least one connector includes at least one carbon nanotube interconnect interposed between the first end and the second end, the at least one carbon nanotube interconnect configured to inhibit heat flow to the second end while delivering an electrical signal to the second end.

6. The cryogenic assembly of claim 5, wherein the connector further comprises:
at least one conductive element including a first element end electrically connected to the electronic power control module, and a second element end located opposite the first element end;
the at least one carbon nanotube interconnect having a first nanotube end electrically connected to the second element end, and a second nanotube end located opposite the first nanotube end; and
at least one conductive segment having a first segment end electrically connected to the second nanotube end, and a second segment end electrically connected to the cryogenic interface of the vacuum unit.

7. The cryogenic assembly of claim 6, wherein the at least one conductive element has the first thermal conductivity, and wherein the at least one carbon nanotube interconnect has the second thermal conductivity.

8. The cryogenic assembly of claim 7 wherein the at least one conductive element is disposed within the cryogenic interface of the vacuum unit.

9. A connector, comprising:
at least one conductive element including a first end configured to receive an electrical signal and a second end configured to output the electrical signal to a cryogenic assembly; and
at least one carbon nanotube interconnect interposed between the first end and the second end, the at least one carbon nanotube interconnect configured to inhibit heat flow to the second end while maintaining electrical conductivity between the first end and the second end.

10. The connector of claim 9, wherein the at least one conductive element has a first thermal conductivity and the at least one carbon nanotube interconnect has a second thermal conductivity that is less than the first thermal conductivity.

11. The connector of claim 10, wherein the at least one conductive element is configured to emit a first temperature and the at least one carbon nanotube interconnect is configured to emit a second temperature that is less than the first temperature.

12. The connector of claim 11, wherein the at least one carbon nanotube interconnect has a first nanotube end electrically connected to an element end of the at least one conductive element, and a second nanotube end located opposite the first nanotube end, and wherein the connector further comprises:
at least one conductive segment having a first segment end electrically connected to the second nanotube end, and a second segment end electrically configured to output at least one electrical signal.

13. The connector of claim 12, wherein the at least one conductive element has the first thermal conductivity, and the at least one carbon nanotube interconnect has the second thermal conductivity.

14. The connector of claim 13, wherein the at least one conductive element is a metal wire.

15. A method of improving power efficiency of a cryogenic assembly, the method comprising:
outputting an electrical signal to a first portion of an electrical connector, the electrical signal inducing a heat flow through the first portion of the electrical connector;
inhibiting the heat flow from flowing to a second portion of the electrical connector, the second portion of the electrical connector existing at a cryogenic temperature; and
delivering the electrical signal to the second portion of the electrical connector, the second portion electrically connected to the cryogenic assembly such that the power efficiency is improved.

16. The method of claim 15, further comprising:
outputting an electrical signal to a first end of at least one conductive element, the electrical signal inducing the heat flow through the at least one conductive element;
delivering the electrical signal to at least one carbon nanotube interconnect electrically connected to a second end of the at least one conductive element; and
inhibiting the heat flow through the at least one conductive element via the at least one carbon nanotube interconnect to reduce parasitic heat flow in the cryogenic assembly.

17. The method of claim 16, further comprising delivering the electrical signal through the carbon nanotube interconnect while simultaneously blocking the heat flow through the carbon nanotube interconnect.

18. The method of claim 17, further comprising delivering the electrical signal through the carbon nanotube interconnect to a conductive segment having a first end connected to the carbon nanotube interconnect and a second end connected to the cryogenic assembly.

19. The method of claim 18, further comprising emitting a first temperature from the at least one conductive element and emitting a second temperature from the conductive segment, the second temperature being less than the first temperature.

20. The method of claim 19, wherein the first temperature is based on a first heat flow of the at least one conductive element and the second temperature is based on a second heat flow of the carbon nanotube interconnect, the second heat flow being less than the first heat flow.
